(19) United States
(12) Patent Application Publication
(10) Pub. No.: US 2012/0202068 A1
(43) Pub. Date: Aug. 9, 2012

(54) PROCESS FOR DEPOSITION OF THIN LAYERS OF METAL OXIDES

(75) Inventors: JOACHIM BILL, WEIL DER STADT (DE); ZAKLINA BURGHARD, MAGSTADT (DE); DEENAN SANTHYA, DELHI (IN)

(73) Assignees: BASF SE, LUDWIGSHAFEN (DE); UNIVERSITAET STUTTGART, STUTTGART (DE); MAX-PLANCK-GESELLSCHAFT ZUR FÖRDERUNG DER WISSENSCHAFTEN E.V., MUENCHEN (DE)

(21) Appl. No.: 13/364,388

(22) Filed: Feb. 2, 2012

Related U.S. Application Data
(63) Continuation-in-part of application No. PCT/EP2010/061124, filed on Jul. 30, 2010.

(30) Foreign Application Priority Data
Aug. 3, 2009 (EP) 09167102.4

(51) Int. Cl. B32B 9/04; B05D 1/38; B32B 9/02; B32B 17/06; B32B 9/06; B32B 21/04; B05D 1/36; B32B 15/04

(52) U.S. Cl. 428/408; 427/414; 428/457; 428/702; 428/426; 428/537.5; 428/532; 428/537.1; 428/473; 428/446

(57) ABSTRACT

The invention relates to a process for the deposition of a metal oxide, such as titanium dioxide, as a thin layer on a substrate, by using particular biopolymers, in particular, a hydrophobin. The process for the deposition of a metal oxide on a substrate (S) comprises the steps of depositing a protein layer (H) comprising at least one hydrophobin on the substrate and the deposition of a metal oxide layer (M) on the protein layer (H) by precipitation from an aqueous solution of a metal salt.

### RELATED APPLICATIONS

This application is a continuation-in-part of PCT/EP2010/061124, filed Jul. 30, 2010, which claims benefit of European application 09167102.4, filed Aug. 3, 2009, both of which are incorporated by reference herein.

### SEQUENCE LISTING

The Sequence Listing associated with this application is filed in electronic format via EFS-Web and is incorporated by reference into the specification. The name of the text file containing the Sequence Listing is SEQUENCE_LISTING_{—}13156-00493-US_ST25.txt. The size of the text file is 72 KB, and the text file was created on Feb. 1, 2012.

### BACKGROUND OF THE INVENTION

The invention relates to a process for the deposition of a metal oxide, such as titanium dioxide, as a thin layer on a substrate, by using particular biopolymers, in particular hydrophobin.

The present invention in particular relates to a deposited smooth, nanocrystalline titanium dioxide thin layer prepared by using an aqueous deposition method comprising a surface active and amphipathic protein of fungal origin, in particular hydrophobin.

Titanium dioxide is one particular functional metal oxide which exhibits favourable optical, electrical and chemical properties, for example high refractive index, permittivity, excellent transmittance of visible light, remarkable solar energy conversion and photocatalysis. Due to its unique properties it shows a wide range of applications across different areas like microelectronic devices, photonic materials, high-efficiency catalysts, gas sensors, hydrogen storage, inorganic membranes, environmental remediation, ductile ceramics, pigmentation, optical devices, microorganism photolysis and medical treatments. Hence, the interest on the fabrication of titanium dioxide (and other metal oxide) thin layers is increasing. In particular, aqueous deposition processes for ceramic thin layers at low temperature by using biopolymers as templates are attractive due to economic and environmental benefits.

Hydrophobins are small proteins of about 100 to 150 amino acids, which occur in filamentous fungi such as Schizophyllum commune. They generally have 8 cysteine (Cys) units in the molecule. Hydrophobins are among the most surface-active proteins of fungal origin and contain diverse amino acid sequences, which are sharing a characteristic pattern of eight Cys residues in their primary sequence by forming four disulfide bridges. The disulfide bridges formed by Cys residues are known to account for the controlled assembly at hydrophilic-hydrophobic interfaces preventing spontaneous self-assembly in solution. These proteins are found to be important for aerial growth (e.g., aerial hyphae, spores and fruiting bodies such as mushrooms) and for the attachment of fungi to solid supports. Interestingly, hydrophobins are remarkably stable and can withstand temperatures near the boiling point of water. Hydrophobins can be isolated from natural sources, but they also can be obtained by recombinant methods, as disclosed, for example, in WO 2006/082 251 or WO 2006/131 564. The prior art already has proposed the use of several hydrophobins for various applications. WO 1996/41882 proposes the use of hydrophobins as emulsifiers and thickeners for hydrophilizing hydrophobic surfaces, for improving the water resistance of hydrophilic substrates, and for producing oil-in-water emulsions or water-in-oil emulsions. It also has been proposed to use hydrophobins as a demulsifier (WO 2006/103251), as an evaporation retardant (WO 2006/128877) or as soiling inhibitor (WO 2006/103215).

There are numerous conventional methods for the deposition of a metal oxide thin layer, including sol-gel chemistry, vapour-phase deposition, dip-coating processes and spray pyrolysis. All these techniques have several drawbacks, such as expensive vacuum equipment, the limitations of line-of-sight deposition; need to heat the substrates above temperatures of 400° C. to crystallize the layers and the use of toxic chemicals. An attractive alternative approach is the aqueous deposition method, which allows layer formation at low temperatures (<100° C.) on functionalised surfaces or organic templates. Basically, layer deposition on large areas, including heat-sensitive as well as geometrically complex substrates, is possible. Aqueous deposition methods include chemical bath deposition (CBD), liquid phase deposition (LPD) and electroless deposition. Although a few investigations on the aqueous deposition of titanium dioxide thin films were carried out on silicon, glass and plastic substrates at low temperature, all methods involve strong acidic conditions, which are not compatible for many devices and processing equipments. Furthermore, these experimental procedures for a surface functionalization, such as chemical modification of surfaces and surface attachment of self assembled monolayer (SAM), are technically complicated and require specialized organic and organometallic synthesis strategies.

One object of the present invention is to provide a cost effective, fast and simple-to-carry-out process with low energy consumption and ecologically favorable steps for the production of a thin metal oxide layer on different types of substrates.

Furthermore, the influence of organic additives, in particular of proteins, on the formation, growth, and morphology of crystalline particles and layers in various types of precipitation reactions was investigated. The influence of high molecular weight biomolecules, such as proteins, is interesting in view of the technical application but also for the understanding of crystallisation processes in nature, such as biomineralization and biocrystallization. Examples for biomineralization, which is an extremely widespread phenomenon in nature, are silicates in algae, carbonates in diatoms and invertebrates, calcium phosphates and carbonates in vertebrates, calcium carbonate molluscan shells, bone in mammals and birds, ferric oxide in magnetotactic bacteria. In biomineralization processes, specific proteins excreted by living organisms are proved to be used as nucleators, growth modifiers, anchoring units by self-aggregation or assemblies to induce mineralization processes. Hence, synthesis of advanced nano-structured materials using organic molecules derived from living organisms at ambient temperatures and pressures and at neutral pH attracts many researchers due to lower cost and energy requirements, environmental safety and operational flexibility. Key examples for such bioorganic templates are sugars, amino acids, peptides and proteins.

### DESCRIPTION OF RELATED ART

WO 2008/142111 describes the use of hydrophobins as additive in the crystallization of solids (in particular of gypsum) from the aqueous phase. It was demonstrated that the morphology of gypsum crystals precipitated from aqueous phase by evaporation may be influenced by addition of hydrophobin in the aqueous phase.

A method of deposition of hydrophobin on different surfaces (such as plastic polymeric surfaces, glass, metallic surfaces, naturally surfaces like leather, cotton and paper) from aqueous solution is described in WO 2006/082253 and EP-A 1 252 516.

The publication Laaksonen et al. (J. American Chemical Society, 2009) describes the deposition of a cysteine-modified hydrophobin on a hydrophobic surface or a hydrophobic patterned surface by self-assembly. This protein layer was labelled with citrate-stabilized gold nanoparticles to allow microscopic characterisation of the layers.

In recent years, zinc salts were hydrolyzed to zinc oxide in the presence of bioorganic additives at moderate temperature and pH. See, e.g., Bauermann et al. (Chem. Mater. 2006, 18, 2016-2020), who describes the crystallization of zinc oxide from a zinc nitrate solution in the presence of dissolved gelatine and on an immobilized gelatine coating.

Surprisingly, it has now been found that a process for the preparation of a thin layer of a metal oxide can be significantly improved and simplified by first treating a substrate of, e. g., glass, metal, silicon, silicon oxide with small amounts of a specific protein, in particular hydrophobin. It was found that smooth, highly uniform, crack-free, nanocrystalline metal oxide thin layers may be deposited on various types of substrates by using an aqueous phase deposition. Normally, no further modification or activation of the substrate surface is necessary. For example, hydrophobin-modified silicon substrates were exposed at near ambient conditions for the deposition of a highly uniform, crack-free TiO₂ layer, which consists of polycrystalline anatase individual grains, e.g. with a size of about 5 nm.

### BRIEF SUMMARY OF THE INVENTION

The present invention relates to a process for the deposition of a metal oxide on a substrate (S) comprising the following steps:
a) deposition of a protein layer (H) comprising at least one hydrophobin on the substrate (S) by treating a substrate (S) (at least once) with a composition comprising at least one hydrophobin,
b) deposition of a metal oxide layer (M) on the protein layer (H) by precipitation, preferably from an aqueous solution of a metal salt.

Furthermore, the invention relates to novel coatings and coated substrates comprising a protein layer (H) (comprising at least one hydrophobin) and a metal oxide layer (M).

The present invention also relates to the use of specific proteins, in particular the hydrophobins, for the preparation of one or several thin layers of metal oxides on various substrates.

The process allows an eco-friendly, cost effective and simple deposition of one or several metal oxide thin layers, preferably of titanium dioxide, on various substrates, e.g., silicon. The resulting metallic oxide thin layers exhibits excellent mechanical properties, such as high smoothness and hardness and superior high resistant against mechanical stress.

### BRIEF DESCRIPTION OF THE DRAWINGS

FIG. 1 shows a potential mechanism of precipitation (crystallization) of titanium dioxide onto the protein layer comprising hydrophobin.

### DETAILED DESCRIPTION OF THE INVENTION

In the context of the present invention, the term “hydrophobins” should be understood hereinafter to mean polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀C⁶—X₀₋₅—C⁷—X₁₋₅—C⁸Xₘ (I)

wherein each X is an amino sequence consisting of any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly) permissibly as glycosylated or otherwise modified as discussed below. Each X may be the same or different. The numerical indices adjacent each X indicate the number of amino acid residues in the adjacent X, and each amino acid residue within each X independently may be identical or different to adjacent residues. C is cysteine, alanine, serine, glycine, methionine or threonine, wherein at least four of the residues designated C are cysteine, and the indices n and m, independently, are natural numbers between 0 and 500, preferably between 15 and 300, indicating the number of amino acid residues comprising the adjacent X.

The polypeptides of the formula (I) also are characterized by the property that, at room temperature, after coating a glass surface, they bring about an increase in the contact angle of a water droplet of at least 20°, preferably at least 25°, and more preferably 30°, compared to the contact angle of an equally large water droplet on the uncoated glass surface.

The amino acids designated C¹ to C⁸ preferably are cysteines. However, they also may be replaced by other amino acids with similar space-filling, preferably by alanine, serine, threonine, methionine or glycine. However, at least four, preferably at least 5, more preferably at least 6 and in particular at least 7 of positions C¹ to C⁸ consist of cysteines. In the inventive proteins, cysteines may either be present in reduced form or form disulfide bridges with one another. Particular preference is given to the intramolecular formation of C—C bridges, especially that with at least one intramolecular disulfide bridge, preferably 2, more preferably 3, and most preferably 4 intramolecular disulfide bridges.

In the case of the above-described exchange of cysteines for amino acids with similar space-filling, such C positions are advantageously exchanged in pairs which can form intramolecular disulfide bridges with one another.

If cysteines, serines, alanines, glycines, methionines or threonines are also used in the positions designated with X, the numbering of the individual C positions in the general formulae can change correspondingly.

Preference is given to using hydrophobins of the general formula (II)

Xₙ—C¹—X₃₋₂₅—C²—X₀₋₂—C³—X₅₋₅₀—C⁴—X₂₋₃₅C⁵—X₂₋₁₅—C⁶—X₀₋₂—C⁷—X₃₋₃₅—C⁸—Xₘ (II)

to perform the present invention, wherein X, C and the indices beside X and C are each as defined above, the indices n and m are each numbers between 0 and 350, preferably from 15 to 300, and the proteins additionally feature the above-illustrated change in contact angle, and, furthermore, at least 6 of the residues designated with C are cysteine. More preferably, all C residues are cysteine.

Particular preference is given to using hydrophobins of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices beside X are each as defined above, the indices n and m are each numbers between 0 and 200, and the proteins additionally feature the above-illustrated change in contact angle, and at least 6 of the residues designated with C are cysteine. More preferably, all C residues are cysteine.

The Xₙ and Xₘ residues may be peptide sequences which naturally are also joined to a hydrophobin. However, one residue or both residues may also be peptide sequences which are not naturally joined to a hydrophobin. This is also understood to mean those Xₙ and/or Xₘ residues in which a peptide sequence which occurs naturally in a hydrophobin is lengthened by a peptide sequence which does not occur naturally in a hydrophobin.

If Xₙ and/or Xₘ are peptide sequences which are not naturally bonded to hydrophobins, such sequences are generally at least 20, preferably at least 35 amino acids in length. They may, for example, be sequences of from 20 to 500, preferably from 30 to 400 and more preferably from 35 to 100 amino acids. Such a residue which is not joined naturally to a hydrophobin will also be referred to hereinafter as a fusion partner. This is intended to express that the proteins may consist of at least one hydrophobin moiety and a fusion partner moiety which do not occur together in this form in nature. Fusion hydrophobins composed of fusion partner and hydrophobin moiety are described, for example, in WO 2006/082251, WO 2006/082253 and WO 2006/131564.

The fusion partner moiety may be selected from a multitude of proteins. It is possible for only one single fusion partner to be bonded to the hydrophobin moiety, or it is also possible for a plurality of fusion partners to be joined to one hydrophobin moiety, for example on the amino terminus (Xₙ) and on the carboxyl terminus (Xₘ) of the hydrophobin moiety. However, it is also possible, for example, for two fusion partners to be joined to one position (Xₙ or Xₘ) of the inventive protein.

Particularly suitable fusion partners are proteins that naturally occur in microorganisms, especially in Escherischia coli or Bacillus subtilis. Examples of such fusion partners are the sequences yaad (SEQ ID NO: 16), yaae (SEQ ID NO: 18), ubiquitin and thioredoxin. Also very suitable are fragments or derivatives of these sequences which comprise only some, for example from 70 to 99%, preferentially from 5 to 50% and more preferably from 10 to 40% of the sequences mentioned, or in which individual amino acids or nucleotides have been changed compared to the sequence mentioned, in which case the percentages are each based on the number of amino acids.

Instead of the complete fusion partner, it may be advantageous to use a truncated residue. In particular the truncated residue can comprise at least 20, preferably at least 35 amino acids.

In a further preferred embodiment, the fusion hydrophobin, as well as the fusion partner mentioned as one of the Xₙ or Xₘ groups or as a terminal constituent of such a group, also may have a so-called affinity domain (affinity tag/affinity tail). In a manner known in principle, this comprises anchor groups which can interact with particular complementary groups and can serve for easier work-up and purification of the proteins. Examples of such affinity domains comprise (His)ₖ, (Arg)ₖ, (Asp)ₖ, (Phe)ₖ or (Cys)ₖ groups, where k generally is a natural number from 1 to 10. It may preferably be a (His)ₖ group, where k is from 4 to 6. In this case, the Xₙ and/or Xₘ group may consist exclusively of such an affinity domain, or else an Xₙ or Xₘ group, which is or is not naturally bonded to a hydrophobin, that is extended by a terminal affinity domain.

The hydrophobins used in accordance with the invention may also be modified in their polypeptide sequence, for example by glycosylation, acetylation or else by chemical crosslinking, for example with glutaraldehyde.

One property of the hydrophobins (or derivatives thereof) used in accordance with the invention is the change in surface properties when the surfaces are coated with the proteins. The change in the surface properties can be determined experimentally by measuring the contact angle of a water droplet before and after the coating of the surface with the protein and determining the difference of the two measurements.

The performance of contact angle measurements is known in principle to those skilled in the art. The measurements are based on room temperature and water droplets of 5 μml and the use of glass plates as substrate. The exact experimental conditions for an example of a suitable method for measuring the contact angle are known in the literature. Under the conditions mentioned there, the fusion proteins used in accordance with the invention have the property of increasing the contact angle by at least 20°, preferably at least 25°, more preferably at least 30°, compared in each case with the contact angle of an equally large water droplet with the uncoated glass surface.

Particularly preferred hydrophobins for performing the present invention are the hydrophobins of the dewA, rodA, hypA, hypB, sc3, basf1, basf2 type as disclosed in WO 2006/082251. Unless stated otherwise, the sequences specified below are based on the sequences disclosed herein and in WO 2006/082251 (see table with the SEQ ID numbers). Especially suitable in accordance with the invention are the fusion proteins yaad-Xa-dewA-his (SEQ ID NO: 20), yaad-Xa-rodA-his (SEQ ID NO: 22) or yaad-Xa-basf1-his (SEQ ID NO: 24), with the polypeptide sequences specified in brackets and the nucleic acid sequences which code therefore, especially the sequences according to SEQ ID NO: 19, 21, 23. More preferably, yaad-Xa-dewA-his (SEQ ID NO: 20) can be used.

Proteins which, proceeding from the polypeptide sequences shown in SEQ ID NO. 20, 22 or 24, arise through exchange, insertion or deletion of from at least one up to 10, preferably 5 amino acids, more preferably 5% of all amino acids, and which still have the biological property of the starting proteins to an extent of at least 50%, are also particularly preferred embodiments. A biological property of the proteins is understood here to mean the change in the contact angle by at least 20°, which has already been described.

Derivatives particularly suitable for performing the present invention are derivatives derived from yaad-Xa-dewA-his (SEQ ID NO: 20), yaad-Xa-rodA-his (SEQ ID NO: 22) or yaad-Xa-basf1-his (SEQ ID NO: 24) by truncating the yaad fusion partner. Instead of the complete yaad fusion partner (SEQ ID NO: 16) with 294 amino acids, it may be advantageous to use a truncated yaad residue. The truncated residue should, though, comprise at least 20, preferably at least 35 amino acids. For example, a truncated radical having from 20 to 293, preferably from 25 to 250, more preferably from 35 to 150 and, for example, from 35 to 100 amino acids may be used. One example of such a protein is yaad40-Xa-dewA-his (SEQ ID NO: 26), which has a yaad residue truncated to 40 amino acids.

A cleavage site between the hydrophobin and the fusion partner or the fusion partners can be utilized to split off the fusion partner and to release the pure hydrophobin in underivatized form (for example by BrCN cleavage at methionine, factor Xa cleavage, enterokinase cleavage, thrombin cleavage, TEV cleavage, etc.).

The hydrophobins used in accordance with the invention for the process of deposition of a thin layer of metallic oxide can be prepared chemically by known methods of peptide synthesis, for example by Merrifield solid-phase synthesis.

Naturally occurring hydrophobins can be isolated from natural sources by means of suitable methods. Reference is made by way of example to Wosten et al., Eur. J Cell Bio. 63, 122-129 (1994) or WO 1996/41882.

A recombinant production process for hydrophobins is described by US 2006/0040349.

Fusion proteins can be prepared preferably by genetic engineering methods, in which one nucleic acid sequence, especially DNA sequence, encoding the fusion partner and one encoding the hydrophobin moiety is combined in such a way that the desired protein is generated in a host organism as a result of gene expression of the combined nucleic acid sequence. Such a preparation process is disclosed, for example, by WO 2006/082251 or WO 2006/082253.

The proteins can be purified by known chromatographic processes, such as molecular sieve chromatography (gel filtration) such as Q Sepharose chromatography, ion exchange chromatography and hydrophobic chromatography, and also with other customary processes such as ultrafiltration, crystallization, salting-out, dialysis and native gel electrophoresis. Suitable processes are described, for example, in Cooper, F. G., Biochemische Arbeitsmethoden [Biochemical Techniques], Verlag Walter de Gruyter, Berlin, New York, or in Scopes, R., Protein Purification, Springer Verlag, New York, Heidelberg, Berlin.

It may be particularly advantageous to ease the isolation and purification of the fusion hydrophobins by providing them with specific anchor groups which can bind to corresponding complementary groups on solid supports, especially suitable polymers. Such solid supports may, for example, be used as a filling for chromatography columns, and the efficiency of the separation can generally be increased significantly in this manner. Such separation processes are also known as affinity chromatography. For the incorporation of the anchor groups, it is possible to use, in the preparation of the proteins, vector systems or oligonucleotides which extend the cDNA by particular nucleotide sequences and hence encode altered proteins or fusion proteins. For easier purification, modified proteins comprise so-called “tags” which function as anchors, for example the modification known as the hexa-histidine anchor. Fusion hydrophobins modified with histidine anchors can be purified chromatographically, for example, using nickel-SEPHAROSE® as the column filling. The fusion hydrophobin can subsequently be eluted again from the column by means of suitable agents for elution, for example an imidazole solution.

In a simplified purification process as described in WO2006/082253 it is possible to dispense with the chromatographic purification. To this end, the cells are first removed from the fermentation broth by means of a suitable method, for example by microfiltration or by centrifugation. Subsequently, the cells can be disrupted by means of suitable methods, for example by means of the methods already mentioned above, and the cell debris can be separated from the inclusion bodies. The latter can advantageously be effected by centrifugation. Finally, the inclusion bodies can be disrupted in a manner known in principle in order to release the fusion hydrophobins. This can be done, for example, by means of acids, bases, and/or detergents. The inclusion bodies with the fusion hydrophobins used in accordance with the invention can generally be dissolved completely even using 0.1 M NaOH within approximately 1 hour. The purity of the fusion hydrophobins obtained by this simplified process is generally from 60 to 80% by weight based on the amount of all proteins. The solutions obtained by the simplified purification process described can be used to perform this invention without further purification.

The hydrophobins prepared as described may be used either directly as fusion proteins or, after detachment and removal of the fusion partner, as “pure” hydrophobins.

The fusion hydrophobins can be used to perform the process of this invention as such or, after eliminating and removing the fusion partner, as “pure” hydrophobins. A splitting is advantageously undertaken after the isolation of the inclusion bodies and their dissolution.

The fusion hydrophobin can also be isolated from the solution as a solid. This can, for example, be affected by freeze-drying or spray-drying in a manner which is known in principle.

The present invention in particular relates to a process for the deposition of a metal oxide thin layer, in which at least one process step is carried out with a composition which comprises a hydrophobin derivative. If appropriate, the composition which comprises the hydrophobin derivative may comprise further components.

Preferably, the hydrophobin derivative is used in the process together with water. The amount of the hydrophobin derivative normally is, based on the overall composition, from 0.1 to 1000 ppm, in particular from 1 to 500 ppm. In particular, the hydrophobin derivative is a fusion hydrophobin or a derivative thereof. More preferred, the used hydrophobin derivative is a fusion hydrophobin selected from the group of yaad-Xa-dewA-his (SEQ ID NO: 20), yaad-Xa-rodA-his (SEQ ID NO: 22) or yaad-Xa-basf1-his (SEQ ID NO: 24), were yaad may also be a truncated yaad′ fusion partner having from 20 to 293 amino acids.

One aspect of the invention is directed to a process for the deposition of a metal oxide on a substrate (S) comprising the following steps:
a) deposition of a protein layer (H) comprising at least one hydrophobin on a substrate (S) by treating the surface of the substrate (S) with a composition comprising at least one hydrophobin,
b) deposition of a metal oxide layer (M) on the protein layer (H) by precipitation from an aqueous solution of a metal salt.

Particularly, in the first process step a), the hydrophobin may be self-assembled on a substrate (S), preferably a hydrophilic substrate, more preferably a metallic substrate or metalloid substrate, more preferably a silicon substrate. In particular, thin layers of titanium dioxide can be deposited on the surface of the hydrophobin layer by a self-assembly deposition.

The general methods of deposition of a self-assembled hydrophobin layer (H) on a substrate are known from the state of art, e.g., from WO2006/103215. Deposition of a protein layer (H) (process step a) is preferably carried out by treating a substrate (S) once, twice or several times with a composition comprising at least one hydrophobin. Preferably an aqueous solution comprising at least one hydrophobin is used. This treatment may be for example carried out by immersing a substrate (S) in horizontal or vertical orientation into the hydrophobin solution; by spraying the hydrophobin solution onto a substrate (S) or by coating the hydrophobin solution via knife application onto a substrate (S).

Preferably, the process step is carried out with a composition comprising at least one hydrophobin in an amount of 0.1 to 1000 ppm, preferably 1 to 500 ppm, more preferred 1 to 100 ppm.

In a preferred embodiment, the process step a) is carried out under pH conditions in the range of 3 to 10, preferably in the range of 7 to 10, more preferably in the range of 7 to 9.

In particular, the treatment of a substrate (S) with a composition comprising at least one hydrophobin (process step a) is performed at a temperature in the range of 20° C. to 100° C., preferably in the range of 20° C. to 80° C., more preferably in the range of 45° C. to 70° C., most preferably in the range of 65° C. to 75° C.

In particular, the treatment of a substrate (S) with a composition comprising at least one hydrophobin (process step a) is carried out for a period of time in the range of 0.1 to 10 hours, preferably in the range of 0.1 to 8 hours, more preferably in the range of 0.1 to 5 hours. Preferably process step a is performed for 0.1 to 8 hours and a temperature in the range of 45° C. to 70° C.

In a further embodiment the process step a) can be carried out under assistance of microwave irradiation. In this embodiment the treatment is in particular performed for a period of time in the range of 1 minutes to 8 hours, preferably in the range of 2 minutes to 5 hours, more preferably in the range of 5 minutes to 2 hours.

In particular the composition comprising at least one hydrophobin, preferably the aqueous solution of a hydrophobin, comprise further additives such as buffer, surfactant, biocide. In a preferred embodiment of the invention the aqueous solution of a hydrophobin comprises a buffer such as phosphate buffer, carbonate buffer or tris(hydroxymethyl)aminomethane (TRIZMA®).

Furthermore, preferably the present invention is directed to a process, wherein the protein layer (H) comprises at least one fusion hydrophobin.

Furthermore, preferably is a process, wherein the protein layer (H) comprises at least one hydrophobin as described about, in particular selected from the group consisting of yaad-Xa-dewA-his (SEQ ID NO: 20), yaad-Xa-rodA-his (SEQ ID NO: 22) and yaad-Xa-basf1-his (SEQ ID NO: 24). In particular one embodiment is directed to a process for the deposition, wherein the protein layer (H) comprises at least one hydrophobin selected from the group consisting of yaad-Xa-dewA-his (SEQ ID NO: 20), yaad-Xa-rodA-his (SEQ ID NO: 22), yaad-Xa-basf1-his (SEQ ID NO: 24) and said hydrophobins comprising a truncated yaad fusion partner.

In a particular embodiment of the invention the protein layer (H) is primarily composed of at least one hydrophobin selected from the group consisting of yaad-Xa-dewA-his (SEQ ID NO: 20), yaad-Xa-rodA-his (SEQ ID NO: 22) and yaad-Xa-basf1-his (SEQ ID NO: 24).

Preferably the protein layer (H) which comprises at least one hydrophobin is deposited on a substrate (S) in the range of 0.1 to 10 mg/m² (protein prosubstrate), preferably in an amount from 0.5 to 5 mg/m².

There are several ways of how the process step b) deposition of metal oxide thin layer (M) is carried out:

Optionally, the protein layer (H) obtained in process step a) can be washed and/or dried before the deposition of a metal oxide layer (M).

In one embodiment, the process step b) is carried out directly after process step a) without a drying step.

The metal oxide layer (M) may comprise in particular a metal oxide wherein the metal is selected from the IVa-main group, Ib-subgroup, IIb-subgroup, IVb-subgroup and VIIIb-subgroup of the periodic table of elements. In particular, the invention relates to a process of deposition of metal oxide as described about, wherein the metal oxide layer (M) comprises at least one metal oxide selected from the group consisting of titanium dioxide, zinc oxide, tin oxide (e.g. tin monoxide, tin dioxide) and silicon dioxide.

The metal salt, which can be used for preparation of an aqueous solution of metal salt mentioned in process step b) can be selected e.g. from an aqueous-soluble metal salt of the corresponding metal ion. The term “water-soluble” refers herein to solubility in water (20° C.) higher than 10 g/l. In particular the water soluble metal salt can be selected from water-soluble Ti(IV) salts (e.g. titanium (IV) bis(ammonium lactate)dihydroxide) or zinc salts (e.g. zinc nitrate)

Deposition of metal oxide layer (M) on the protein layer (H) by precipitation from an aqueous solution of metal salt (process step b) is preferably carried out by treating protein layer deposited on substrate (S) at least once with an aqueous solution of metal salt. This treatment may, for example, be carried out by immersing a substrate (S) horizontally or vertically into the hydrophobin solution; spraying the hydrophobin solution onto a substrate (S) or by coating the hydrophobin solution via knife application. Preferably the substrate (S) coated with protein layer (H) is immersed in the horizontally and/or vertically orientation in an aqueous solution of metal salt.

The precipitation of the metal oxide (process step b) is in particular induced by the addition of a precipitating agent. In a preferred embodiment of the deposition process the precipitation is induced by change of pH of the aqueous solution. In particular the precipitation is induced by addition of a base. The base may be selected from alkali hydroxide, earth alkali hydroxide, ammonia, ternary amides. Preferably the base is an alkali hydroxide.

In a preferred embodiment process step b is carried out under a pH in the range of 7 to 10, preferably in the range of 7 to 9, more preferably in the range of 7 to 8. Generally, the selected pH is depended on solubility of the metal oxide which should be deposited. In a preferred embodiment the metal oxide is titanium dioxide and the deposition of metal oxide layer (M) on the protein layer (H) by precipitation from an aqueous solution of metal salt is performed at pH in the range of 7 to 10, preferably from 8.5 to 9.5 and the deposition temperature is in the range of 60° C. to 80° C., preferably in the range of 65° C. to 75° C.

In particular, the precipitation of the metal oxide (process step b) is performed at a temperature in the range of 1° C. to 100° C., preferably in the range of 20° C. to 80° C., more preferably in the range of 60° C. to 80° C., most preferably in the range of 65° C. to 75° C.

In particular the precipitation of the metal oxide (process step b) is carried out for a period of time in the range of 0.5 to 10 hours, preferably in the range of 0.5 to 8 hours, more preferably in the range of 0.5 to 5 hours. Preferably process step a is performed for 0.5 to 8 hours and at temperature in the range of 60° C. to 80° C.

In a further embodiment the process step b) can be carried out under assistance of microwave irradiation. In this embodiment the treatment is in particular performed for a period of time in the range of 10 minutes to 8 hours, preferably in the range of 10 minutes to 5 hours, more preferably in the range of 10 minutes to 2 hours.

Aqueous solution in the term of the present invention means aqueous compositions comprising water in an amount of at least 65 weight-% preferably of at least 80 weight-% and optionally one or more water-soluble solvents which may be selected from mono alcohols, such as methanol, ethanol and propanol, higher alcohol, such as ethylene glycol or polyether polyole, ether alcohols, such as butyl glycol or methoxy propanol. Preferably pure water is used as solvent. The selection of solvent composition is only limited by the solubility of the relevant compounds in particular hydrophobin and metal salt.

In particular the process for the deposition as described about may comprise the following steps:
a) deposition of a protein layer (H) comprising at least one hydrophobin on the substrate from aqueous solution in a self-assembly process,
b) deposition of metal oxide layer (M) on the hydrophobin layer (H) by precipitation from an aqueous solution of metal salt by adding a base,
c) optionally washing the substrate (S) coated with protein layer (H) after process step a) with an aqueous solution and/or drying substrate (S) which is coated with a protein layer (H).

In a particular embodiment of the invention the process of deposition as described about comprises the following steps:
a) deposition of a protein layer (H) consisting essentially of at least one hydrophobin, preferably at least one hydrophobin selected from the group consisting of yaad-Xa-dewA-his (SEQ ID NO: 20), yaad-Xa-rodA-his (SEQ ID NO: 22) and yaad-Xa-basf1-his (SEQ ID NO: 24), on the substrate (S) as described,
b) deposition of a metal oxide layer (M) consisting essentially of titanium dioxide on the protein layer (H) by precipitation from an aqueous solution of a water soluble titanium (IV) salt wherein the deposition is carried out at a pH in the range of 8 to 9 and a temperature in the range of 20° C. to 80° C.

Preferably the metal oxide layer (H) obtained by inventive deposition process exhibits a mean layer thickness in the range of 20 to 300 nm.

Optionally the process according to the present invention may comprise one or more of the following finishing steps:
washing the metal oxide layer with a aqueous solution,
drying the metal oxide layer (M), in particular in at least one step at a temperature in the range of 30° C. to 60° C. and a relative humidity in the range of 90% to 10%. Preferably the relative humidity is reduced stepwise during drying process,
coating of the metal oxide layer (M) with a protective layer, in particular with an UV protective clear varnish and/or an layer preventing degradation of protein by protease

Optionally, the surface of substrate (S) may be cleaned before deposition of protein layer (H). In particular for the case that the substrate (S) is a metallic substrate or a metalloid substrate such as silicon, the substrate may be cleaned with chloroform, acetone and/or ethanol. Particularly the metallic substrate or metalloid substrate surface may be oxidized, for example in piranha solution (70 vol. % of H₂SO₄, 30 vol. % of 30 wt. H₂O₂ aqueous solution).

The process of deposition of metal oxide according to the present invention may be applied to a high number of several substrates which may exhibit hydrophilic or hydrophobic surfaces. The self-assembly of hydrophobins are known on both hydrophilic and hydrophobic surfaces. In particular the substrate (S) is selected from metal, metalloid, metal oxide, glass, polymer, natural substrates (such as paper, cotton, wood, leather), ceramic, textile, graphite. In a particular embodiment the present invention relates to a process of deposition of metal oxide as described about, wherein substrate (S) is a metallic substrate or a metalloid substrate preferably silicon.

In one embodiment the substrate exhibits a hydrophilic surface. According to different characterization method it is stated that the hydrophobin self-assembled layers shows rodlet assembly with the attachment of hydrophilic portion of the hydrophobin molecules to a hydrophilic substrate surface and exposing the hydrophobic part of the molecule. Interestingly, AR-XPS analysis confirms the stability of the protein molecules up to the boiling point of water

In a further aspect the invention is directed to a coated substrate and to a coating deposited on a substrate. In particular the present invention relates to a coated substrate comprising:
i) a substrate (S);
iii) a protein layer (H) on the surface of the substrate which comprises at least one hydrophobin, preferably at least one hydrophobin selected from the group consisting of yaad-Xa-dewA-his (SEQ ID NO: 20), yaad-Xa-rodA-his (SEQ ID NO: 22) and yaad-Xa-basf1-his (SEQ ID NO: 24);
iii) a metal oxide layer (M) deposited on the protein layer.

In particular, a coated substrate comprises a metal oxide layer (M), wherein the metal oxide layer (M) comprises at least one metal oxide selected from the group consisting of a titanium dioxide, zinc oxide, tin oxide and silicon dioxide.

In particular, the coating comprises a protein layer (H), which is primarily composed of at least one hydrophobin selected from the group consisting of yaad-Xa-dewA-his (SEQ ID NO: 20), yaad-Xa-rodA-his (SEQ ID NO: 22) and yaad-Xa-basf1-his (SEQ ID NO: 24), and metal oxide layer (M), which is primarily composed of at least one metal oxide selected from the group consisting of titanium dioxide, zinc oxide, tin oxide (e.g. tin monoxide, tin dioxide) and silicon dioxide.

Furthermore, the invention is directed to the use of a hydrophobin in a process for the deposition of metal oxide layers on a substrate (S).

In one embodiment the invention is directed to the use of a hydrophobin in a process for the deposition of metal oxide layers on a substrate (S), wherein the substrate (S) has a hydrophilic surface.

Particular hydrophobin for use in a process of deposition of metal oxide layers on a substrate (S) is selected from the group consisting of yaad-Xa-dewA-his (SEQ ID NO: 20), yaad-Xa-rodA-his (SEQ ID NO: 22) and yaad-Xa-basf1-his (SEQ ID NO: 24).

In a preferred embodiment hydrophobin for use in a process of deposition of metal oxide layers on a substrate (S) is selected from the group consisting of yaad-Xa-dewA-his (SEQ ID NO: 20), yaad-Xa-rodA-his (SEQ ID NO: 22) and yaad-Xa-basf1-his (SEQ ID NO: 24) and the substrate (S) exhibits a hydrophilic surface.

The novel coating of metal oxide can be used in several fields. For one example the present oxide layer is promising for application in hard tissue replacement. Specifically, artificial materials designed for this purpose should have low elastic modulus to minimize the bone resorption, e.g. for cortical bone this value ranges between 15 and 40 GPa. Accordingly, the hydrophobin-nucleated TiO₂ layers (Young's modulus was found to be 41±2 GPa) can be considered as well-suited for covering the implants.

The resulting protein layer (H) in particular a hydrophobin thin layers on the substrate surface can be characterised using angle-resolved X-ray photoelectron spectroscopy (AR-XPS), atomic force microscopy (AFM) and Fourier Transform Infrared Spectroscopy (FTIR). Additionally, surface potential measurements can also carried out to study zeta potential of self-assembled hydrophobin on silicon.

The microstructure of the metal oxide thin layer (M) in particular titanium dioxide layers may be characterized using atomic force microscopy (AFM), scanning electron microscopy (SEM) and transmission electron microscopy (TEM), which revealed the presence of nanocrystals. The titanium dioxide layers were also characterised using AR-XPS and Fourier Transform Infrared Spectroscopic (FTIR) techniques and appropriate mechanisms involved in layer deposition were discussed. The mechanical properties of the metal oxide layers deposited on the protein layer (H) can for example be studied by nanoindentation tests.

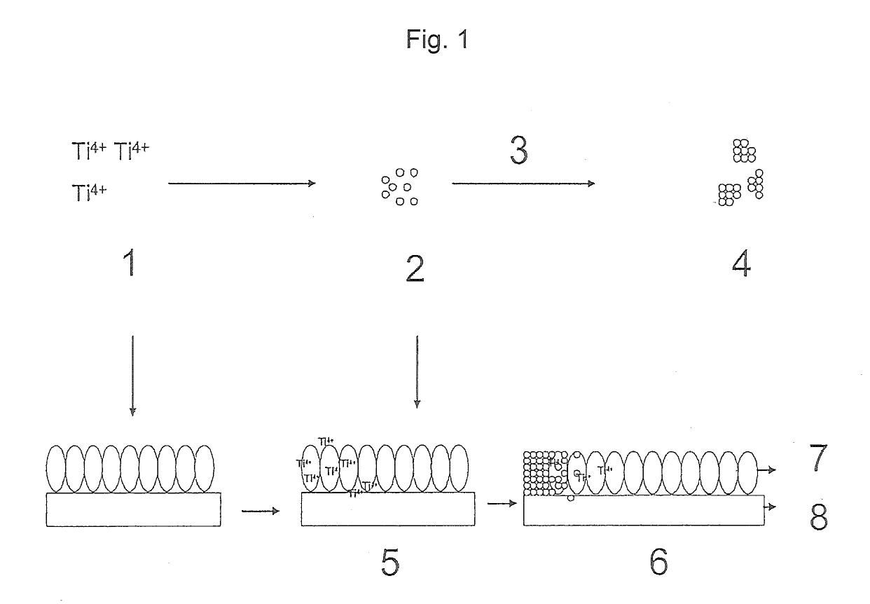

FIG. 1 shows a supposable mechanism of precipitation (crystallization) of titanium dioxide onto hydrophobin comprising layer, wherein the numbers have the following meaning:
1 Precursor solution
2 TiO₂ nanoparticles
3 Aggregation
4 Precipitation
5 Heterogenous nucleation of TiO₂ thin film
6 Homogenous nucleation of TiO₂ thin film
7 Hydrophobin-SAM (self assembled monolayer)
8 Si-wafer.

The metal precursor solution used for metal oxide layer deposition may show a visible turbidity after 15-20 minutes of deposition process. Both heterogeneous and homogeneous nucleation especially for TiO₂ layer deposition is proposed. Mostly, heterogeneous nucleation is expected at the very beginning of the layer deposition that is before the turbidity starts in the depositing solution.

Hence, seed TiO₂ crystals are formed mostly due to the chemical interaction between the functional groups of protein molecule and Ti⁴⁺ ions. Further deposition of TiO₂ layer is expected to be attributed to the attachment of TiOH nanoparticles to the seeds through oxo (—O—) bridges as well as van der Waals forces and subsequent condensation.

According to zeta potential measurement it can be stated that electrostatic attractions between the protein molecules (e.g., hydrophobin) and TiOH nanoparticles are considered to be weaker compared to van der Waals forces.

During the self-assembly, the protein molecules in particular the hydrophobin molecules are expected to undergo conformational change by exposing their polar groups on the hydrophilic piranha treated silica surface and apolar groups at the other surface. From the literature it is also evident that amino acids such as His, Cys and Glu either as free molecules or incorporated in proteins are suitable to form complexes with metal ions. Similarly, there is a possibility for chemical interaction of amino acids in hydrophobins with the Ti(IV)-hydroxy complex through their functional groups such as —COO⁻, —C═O, —OH and —NH₂.

The results of kinetic experiments show three stages of TiO₂ layer growth: lag period, exponential growth period and terminal period. The initial lag indicates a TiO₂ nucleation potential barrier, which is followed by rapid layer growth.

The following examples illustrate the invention in more detail.

### EXAMPLE 1

### Preparation of a Self-Assembly Hydrophobin-Layer

First the substrate preparation was carried out. One side polished p-type single-crystal Si (100) wafers of size 10×10 mm² were used as substrates. The substrates were cleaned in chloroform, acetone and ethanol respectively. The cleaned substrates were oxidized in piranha solution (70 vol. % of H₂SO₄, 30 vol. % of 30 wt. % H₂O₂ aqueous solution) at 90° C. for 1 hour and washed thoroughly using MILLI-Q® water and dried in an argon stream prior to use.

The protein called hydrophobin was obtained from BASF-SE, Ludwigshafen, Germany. The hydrophobin (H*protein B, based on the hydrophobin DewA of A. nidulans, yaad-Xa-dewA-his, SEQ ID NO: 20) belongs to class I of molecular weight 18,825 Da and the isoelectric point of the protein is pH 5.37. Further, the hydrophobin used in this study exhibit temperature stability up to the boiling point of water.

MILLI-Q® water and analytical reagent (AR) grade chemicals were used.

500 μg/ml of hydrophobin solution was prepared by dissolving 50 mg of hydrophobin in 100 ml of 100 mM tris(hydroxymethyl) aminomethane (TRIZMA®) buffer at pH 8. The TRIZMA® buffer was made by mixing the required amount of TRIZMA® HCl and TRIZMA® base in MILLI-Q® water. For the self-assembly of hydrophobin, the piranha treated Si wafers were immersed horizontally in 5 ml aliquots of the protein solution in the TRIZMA® buffer solution at pH 8, covered and placed in an oil bath at various temperatures such as room temperature (22° C.), 45° C., 60° C. and 70° C. for 8 hours. The substrates were then washed gently with MILLI-Q® water and dried with argon flow.

AFM images with scan size 1×1 μm of hydrophobin surfaces prepared at various temperatures (RT to 70° C.) reveal that protein molecules are more closely packed and expanded with increasing temperature.

In order to test the solubility of hydrophobin SAMs, the Si substrate after the self-assembly of the protein at 70° C. was gently heated up to 90° C. in 5 ml of MILLI-Q® water for 1 h under water bath. After an hour the substrate was separated from the water, dried and subjected to AFM analysis. Interestingly, protein SAMs on the substrate was found to be intact other than slight expansion of the molecules. The separated water was also subjected to the Bradford test for protein analysis (Anal. Biochem. 1976, 72, 248) and the corresponding protein was found to be not detected in the water sample. The observed insoluble nature of hydrophobin B is in good agreement with hydrophobin SC3 in which rodlet assembly was found to be very stable and only harsh chemicals such as pure trifluoroacetic or formic acid can dissolve it.

The used amphipathic hydrophobin increased the water contact angle of the substrate from 0° for the bare substrate to 67° for the hydrophobin-covered one. The increase in the water contact angle of the hydrophilic substrate after hydrophobin assembly is due to the attachment of hydrophilic portion of the hydrophobin molecules to the substrate surface, exposing the hydrophobic part of the molecule.

At 70° C., the average thickness of the hydrophobin layers was found to be 12 nm with a RMS roughness as low as 0.506 nm.

The results of the XPS analysis of the Piranha-treated Si substrates before and after coating with hydrophobin SAM at various deposition temperatures shows formation of thicker and more densely-packed hydrophobin overlayers towards higher deposition temperatures as also observed by AFM.

### EXAMPLE 2

### Deposition of TiO₂ Layers

Titanium (IV) bis(ammonium lactate) dihydroxide was procured from Sigma-Aldrich. MILLI-Q® water and analytical reagent (AR) grade chemicals were used.

A stock solution of 1M Ti⁴⁺ was freshly prepared by diluting 50 wt % titanium (IV) bis(ammonium lactate) dihydroxide solution at room temperature and further diluted to 0.05M Ti⁴⁺ with simultaneous control of pH to 8.89 by drop-wise addition of 3M NaOH with constant stirring. The hydrophobin-coated substrates at 70° C. were immersed in 5-ml aliquots of the deposition solution, and placed in oil bath at 60° C., 70° C. and 80° C. for 8 h in the horizontal or vertical orientation. Before the deposition, the solution was agitated ultrasonically for 10 min to dispel most of the air in the solution. The samples were washed abundantly with MILLI-Q® water and dried in an oven as described by Razgon et al. (J. Mater. Res. 2005, 20, 2544). In this method, the samples were placed into the drying chamber at 40° C. with 80% initial relative humidity and the humidity was reduced in a steady ramp down to 20%. At the end of the drying procedure, samples were cooled to 25° C. over 3 h and then removed into the ambient environment. The overall time of this drying procedure was 90 h.

It is also pertinent to mention that TiO₂ layers were not deposited on piranha oxidised Si wafers at pH 8.89, which is attributed to the almost similar surface charge of depositing nanoparticles (−45±7 mV) and piranha treated silicon surface (−38±7 mV).

Dependence of thin layer thickness and roughness on the deposition time was evaluated directly from SEM and AFM images at various deposition temperatures. In this experiment, renewal of the deposition solution was carried out every two hours. The kinetics of the evolution of the average layer thickness was measured from every one hour up to 8 h of TiO₂ layer deposition time directly from the SEM cross-sectional images.

It is also noteworthy that increase in deposition temperature increases the rate of thin layer deposition due to increase in TiO₂ nucleation.

The root of the mean squared deviation (RMS) in height as measured with AFM is used as a measure of the roughness. The roughness was tested for TiO₂ layers at different deposition times and temperatures. At a deposition temperature of 60° C., a layer roughness was found from 2.27 nm (for 4 hour deposition time) to 27.3 nm (for 8 hour deposition time). For deposition temperature of 70° C. smoother layers with a roughness below 6.5 nm for 8 hours of deposition time are observed. At 80° C. after 4 hours and up to 8 hours of deposition time the roughness of the layer remains more or less at ≈9 nm.

The TiO₂ layer on the Si/hydrophobin SAM substrate deposited at 70° C. for 6 hours was analysed using scanning electron microscopy (SEM) and atomic force microscopy (AFM). SEM images (top view of TiO₂layers) and AFT images (height plot) of TiO₂ film showed a homogeneous TiO₂ layer microstructure. The TiO₂ layer contained particularly grains of size less than 5 nm. The SEM images (tilted by 20°) of the cross section of a TiO₂ layer showed the silicon basis substrate, the hydrophobin layer and the deposited TiO₂ layer. The TiO₂ layer has a mean layer thickness of about 240 nm.

TEM bright field image of the cross section of a TiO₂ layer confirms 240 nm mean layer thickness observed after 6 hours deposition on a hydrophobin SAM at 70° C. An intermediate dark contrast layer seen between the TiO₂ layer and silicon substrate may be attributed to the hydrophobin SAM and the amorphous silicon oxide layer induced by piranha cleaning. The corresponding selected area electron diffraction (SAD) pattern indicates that the TiO₂ layer consists of polycrystalline anatase. High-resolution TEM shows individual grains with a size of about 5 nm.

The thin layer coating was tested to be adherent by a simple tape peel test with commercial adhesive tape and ultrasonic cleaning indicating a strong interaction between the hydrophobin SAM and TiO₂ nano particles.

The RMS roughness of the corresponding layer at thickness of about 240 nm was measured from AFM measurements to be about 5.5 nm, which confirms the smoothness of the layer.

The chemical constitution of the TiO₂ layer surfaces (deposited for 0.5 h and 8 h at 70° C.) were also analyzed by XPS. It followed that the TiO₂ layer formed after 8 hours of deposition contains only a single valence state of Ti⁴⁺ at its surface with a corresponding Ti 2p3/2 BE of 458.9^{±0.2} eV. For much shorter TiO₂ deposition times of 0.5 hours, on the other hand, the layer surface also contains a considerable amount of Ti in a lower valence state (designated as Ti^{δ+} with δ<4+) with a corresponding Ti 2p3/2 BE of 457.3^{±0.2} eV. These suboxidic Ti species at the initial TiO₂ surface hint for the chemical interaction of the hydrophobin SAM with the Ti(IV)-hydroxo complexes through their functional groups during the initial stages of layer deposition.

FTIR spectra of the TiO₂ sample deposited on hydrophobin collected from several Si wafers show amide I and amide II bands at 1626.9 cm⁻¹ and 1518.3 cm⁻¹ respectively. The observed incorporation of amide I and II in the TiO₂ layer provides additional evidence for the interaction of the protein with titanium (IV) precursor during the layer deposition.

### EXAMPLE 3

### Description of Characterization Techniques

AR-XPS

AR-XPS analysis of the Si substrates after the Piranha-treatment, after coating with hydrophobin (at various temperatures in the range of room temperature to 80° C.), as well as after subsequently TiO₂ deposition (with layer thicknesses of ˜20 nm and ˜300 nm), were performed with a Thermo VG Thetaprobe system employing monochromatic Al Kα radiation (hv=1486.68 eV; spot size 400 μm). XPS survey spectra, covering a binding energy (BE) range from 0 eV to 1200 eV, were recorded with a step size and constant pass energy of 0.2 eV and of 200 eV, respectively.

AFM (Atomic Force Microscopy) and Nanoindentation Testing

Atomic force microscopy and nanoindentation testing were carried out similarly as reported by Burghard et al. (Adv. Mater. 2007, 19, 970). AFM images were recorded in tapping mode using a commercial scanning probe microscope (NanoScope III Multimode, Digital Instruments) with a silicon cantilever (Veeco). The thickness of the hydrophobin layer was determined by carefully scratching the layer with a sharp needle and measuring the depth of the created scratch.

RMS Roughness

The RMS roughness of the hydrophobin SAM and TiO₂ layers were measured from areas of 1×1 μm² size. Nanomechanical tests on the TiO₂ layer were performed with the aid of a scanning nanoindenter comprising a depth-sensing force transducer (Hysitron TriboScope) combined with the above mentioned scanning probe microscope. A cube corner diamond indenter with a nominal tip radius of ˜40 nm was used, which permits creating plastic deformation within small indentation depth, and thus enables remaining within the plastic and elastic field inside the layer. In this manner, the impact of the substrate is minimized, which is crucial for investigating very thin layers. Working with shallow indentation depths was facilitated by the high load and displacement resolution (100 nN and 0.2 nm, respectively) of the 30 mN force transducer. The tip was calibrated on a fused silica standard sample within the penetration depth range of 20 to 100 nm. In all indentations, the applied force was varied during subsequent load/partial unload—cycles over 25 steps, up to a maximum load of 300 μN. This value was chosen in order to reach a maximum contact depth of about 100 nm, which corresponds to one third of the measured layer thickness. The indentations were arranged in the form of regular arrays with a distance of 2.5 μm between them. The force-displacement curves were evaluated by the software implemented in the nanoindenter, which is based upon the method proposed by Oliver and Pharr (J. Mater. Res. 1992, 7, 1564) and the results were averaged over 30 indentations.

FTIR Spectroscopic Studies

FTIR spectroscopic studies of hydrophobin coated piranha Si wafers and deposited TiO₂ samples on hydrophobin-coated silica surfaces were carried out using a Nicolet Avatar 360 FTIR spectrometer with appropriate reference material.

Water Contact Angle (WCA)

Water contact angle (WCA) on piranha-treated Si wafers before and after hydrophobin self-assembly were measured at ambient temperature using an optical contact angle meter (Krüss contact angle measuring system G10). The WCA values were averaged from five measurements at different locations.

Surface Potential Measurements and Zeta Potential Measurements

Surface potential measurements were carried out using an Anton Paar SurPASS electrokinetic analyzer by investigating the zeta potential of hydrophobin-coated Si wafer surfaces based on the streaming potential and streaming current method with appropriate control experiments. In these studies 0.1M HCl/NaOH was used as a titrant.

Zeta potential measurements on thin layer deposition solutions of 0.05M titanium (IV) bis(ammonium lactate) dihydroxide in the pH range 8-9 were carried out using a Malvern model 3000 HSA ZETASIZER®. 10-ml aliquots of the deposition solution at required pH were gently heated to 70° C. in an oil bath for about 10 min, cooled to room temperature and allowed to equilibrate for 30 min to determine the zeta potential. The pH values of the deposition solutions were controlled by drop-wise addition of 3M NaOH with constant stirring.

Electron Microscopy Studies (SEM and TEM)

SEM investigations on TiO₂ layers were done using a JEOL JSM-6300 F with an accelerating voltage of 3 kV and working distance of 15 mm and a Zeiss DSM 982 Gemini at accelerating voltages of 5 kV and working distance of 9 mm. Cross-sectional specimens for SEM are obtained by scarification of the substrate with wire-cutting pliers and subsequent manual cleaving.

For TEM, a JEOL JEM-4000FX with an accelerating voltage of 400 kV is used. Cross-sectional specimens for TEM studies are prepared according to the method described by Lipowsky et al. (Int. J. Mat. Res. 2006, 97, 607). Lattice spacings were determined using 2D Fast Fourier Transformation (FFT) of selected areas of high resolution TEM images.

### EXAMPLE 4

### Mechanical Properties

The nanomechanical testing was performed on TiO₂ layer deposited on the hydrophobin SAM at a temperature of 70° C. and pH 8.89 (see Example 2). The deposition time of 8 hours resulted in a titanium dioxide thickness of ˜290 nm, as determined from SEM images. The low roughness of ˜6 nm and uniform microstructure of the layer made them suitable for nanoindentation measurements. As the layers were deposited from aqueous solution, the indentations were performed after controlled drying of the samples in order to avoid the influence of residual water. The indentation impression and the AFM section profile clearly shows that no piling-up occurs. This observation witnesses a high rigidity of the layer.

The hardness and Young's modulus was determined from experimental load-contact depth curves. In general, nanoindentation data obtained at shallow penetration depth are affected by the surface roughness of the sample. Moreover, a pronounced influence of the substrate occurs for indentation depths larger than 20% of the total layer thickness.

To account for these limitations, hardness of titanium dioxide layer according to the present invention was determined based upon the contact depth range between 20 and 40 nm.

An averaged hardness value of 4.9±0.3 GPa for the titanium dioxide layer for the contact depth range between 20 and 40 nm was determined and the corresponding Young's modulus was found to be 41±2 GPa.

In Table 1 these values are compared to values from titanium dioxide layers described in the state of art and which are deposited by other processes. For example values according to the present invention are several times larger than those reported in the state of art for TiO₂ layers prepared by CBD utilizing a different precursor solution but similar deposition temperature (hardness 1.5 GPa; Young's modulus 27 GPa).

The measured hardness of titanium dioxide layers according to the present invention is comparable to that reported for electrodeposited TiO₂ layers, which after annealing at 450° C. exhibit a polycrystalline anatase structure.

TABLE 1
Comparison of Hardnesss and Young's modulus of titanium dioxide layers

| | | Young's |
|---|---|---|
| | Hardness, | modulus, |
| | GPa | GPa |
| Titanium dioxide layer according to example 2 | 4.9 ± 0.3 | 41 ± 2 |
| (70° C., pH 8.89) | | |
| Amorphous film prepared by CBD from titanium | 1.5 ± 0.1 | 27 ± 2 |
| peroxo complex at similar temperature | | |
| (Burghard et al., Adv. Mater. 2007, 19, 970) | | |
| Electrodeposited titanium dioxide film, green film | 1.4 | 40 |
| Annealed at 450° C., polycrystalline anatase | 5.5 ± 1 | 228 ± 71 |
| structure (Kern et al., Thin Solid Films 2006, | | |
| 494, 279) | | |
| Sol-Gel derived titanium dioxide film, annealed | 1.54 | 83 |
| at 550° C., polycrystalline anatase structure | | |
| (Olofinjana et al., Wear 241, 174 (2000)) | | |

The observed results on the nanomechanical properties indicate that the titanium dioxide layers produced according to the invention are highly resistant to various types of mechanical stress. The achievement of this mechanical performance is very surprising, because these properties are normally only observed for layers prepared at much higher temperatures. This highlights the strong benefit of using the process which uses hydrophobin as a template for titanium dioxide deposition.

1. A process for depositing a metal oxide on a substrate (S) comprising the steps of
a) depositing a protein layer (H) comprising at least one hydrophobin on the substrate (S) by treating the surface of the substrate (S) with a composition comprising at least one hydrophobin, then
b) depositing a metal oxide layer (M) on the protein layer (H) by precipitation from an aqueous solution of a metal salt.

2. The process of claim 1, wherein the metal oxide layer (M) comprises at least one metal oxide selected from the group consisting of titanium dioxide, zinc oxide, tin oxide and silicon dioxide.

3. A process for depositing a metal oxide on a substrate (S) comprising the steps of
a) depositing a protein layer (H) comprising at least one hydrophobin on the substrate (S) from an aqueous solution in a self-assembly process, then
b) depositing a metal oxide layer (M) on the protein layer (H) by precipitation from an aqueous solution of a metal salt by adding a base, then
c) optionally, performing at least one of washing the substrate (S) coated with the protein layer (H) after process step a) with an aqueous solution or drying the substrate (S) that is coated with the protein layer (H).

4. The process of claim 1, wherein the process step b) is carried out at a temperature of about 1° C. to 100° C.

5. The process of claim 1, wherein the process step b) is carried out at a pH of about 7 to 10.

6. The process of claim 1, wherein the substrate (S) is selected the group consisting of metals, metalloids, metal oxides, glasses, polymers, natural substrates, ceramics, textiles and graphites.

7. The process of claim 1, wherein the process step b) is carried out directly after the process step a) without an intermediate drying step.

8. The process of claim 1, wherein the protein layer (H) consists essentially of at least one hydrophobin and the metal oxide layer (M) consists essentially of titanium dioxide that is precipitated on the protein layer (H) from an aqueous solution of a water-soluble titanium (IV) salt, wherein the metal oxide layer (M) depositing is carried out at a pH of about 8 to 9 and at a temperature of about 20° C. to 80° C.

9. The process of claim 1, wherein the protein layer (H) comprises at least one fusion hydrophobin.

10. The process of claim 1, wherein the protein layer (H) comprises a hydrophobin selected from the group consisting of yaad-Xa-dewA-his (SEQ ID NO: 20), yaad-Xa-rodA-his (SEQ ID NO: 22), yaad-Xa-basf1-his (SEQ ID NO: 24).

11. A coated substrate comprising
a) a substrate (S) selected from the group consisting of metals, metalloids, metal oxides, glasses, polymers, papers, cottons, woods, leathers, ceramics, textiles and graphites;
b) a protein layer (H) deposited on the surface of the substrate comprising at least one hydrophobin; and
c) a metal oxide layer (M) deposited on the protein layer.

12. The coated substrate of claim 11, wherein the metal oxide layer (M) comprises at least one metal oxide selected from the group consisting of titanium dioxide, zinc oxide, tin oxide and silicon dioxide.


SEQUENCE LISTING (26 sequences)

SEQ ID NO: 1 - DNA, 405 bp, Aspergillus nidulans
  CDS (1)..(405): dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Agaricus bisporus
  CDS (1)..(336): hypA hydrophobin
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Agaricus bisporus
  hypA hydrophobin
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Agaricus bisporus
  CDS (1)..(357): hypB hydrophobin
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Agaricus bisporus
  hypB hydrophobin
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): sc3 hydrophobin
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  sc3 hydrophobin
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): BASF1 hydrophobin from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  BASF1 hydrophobin from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): BASF2 hydrophobin from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  BASF2 hydrophobin from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): yaad
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  yaad
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): yaae with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  yaae with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): fusion protein yaad-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  fusion protein yaad-Xa-dewA-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): fusion protein yaad-Xa-rodA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  fusion protein yaad-Xa-rodA-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): fusion protein yaad-Xa-basf1-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  fusion protein yaad-Xa-basf1-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 561 bp, Artificial sequence
  CDS (1)..(561): fusion protein yaad40-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 26 - protein, 187 aa, artificial sequence
  fusion protein yaad40-Xa-dewA-his
MAQTGTERVKRGMAEMQKGGVIMDVINAEQAKIAEEAGAVIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH